(19) United States
(12) Patent Application Publication
(10) Pub. No.: US 2011/0189510 A1
(43) Pub. Date: Aug. 4, 2011

(54) Nano-Composite Anode for High Capacity Batteries and Methods of Forming Same

(75) Inventors: Robert Caracciolo, Lancaster, PA (US); Youssef M. Habib, Lancaster, PA (US)

(73) Assignee: ILLUMINEX CORPORATION, Lancaster, PA (US)

(21) Appl. No.: 12/777,165

(22) Filed: May 10, 2010

Related U.S. Application Data
(63) Continuation-in-part of application No. 61/299,749, filed on Jan. 29, 2010.

(51) Int. Cl. H01M 10/00; H01M 4/02; H01M 4/38; H01M 4/04

(52) U.S. Cl. 429/50; 429/209; 429/220; 429/223; 429/219; 427/58; 977/948; 977/762; 977/890

(57) ABSTRACT

A battery anode comprised of a coated metallic nanowire array is disclosed. In one embodiment, an array of copper nanowires is attached to a copper substrate and coated with amorphous silicon. The center to center spacing of the nanowires and their diameter and the coating thickness are set so that the silicon coating of neighboring nanowires does not touch or severely inhibit electrolyte flow after the silicon layer has expanded due to charge insertion. In another embodiment, the silicon coating fully covers the nanowires and the nanowires provide structural support that ameliorates stress in the silicon film due to charge cycling.

This patent application hereby incorporates by reference and claims priority as a continuation in part to U.S. Patent Application No. 61/299,749 filed on Jan. 29, 2010.

### 1. BACKGROUND

Lithium-ion is the battery chemistry of choice for powering future generations of portable electronics and hybrid and plug-in hybrid electric vehicles (EV), alternative power storage for grid back-up and point-of-use, and many military applications. For example, an Electric Vehicle battery will require high energy density, approximately 200 Wh/kg, high cycle-life, >1000 charge-discharge cycles, ease of maintenance, environmentally friendly, economic, and safe. The battery industry seeks the development of advanced battery chemistries, architectures, and manufacturing processes that can support the above goals. The present invention is a novel nano-composite anode for high-performance LIB and other energy storage applications. In one preferred embodiment, it is a combination of Copper-Silicon (Cu—Si).

Silicon (Si) is one of the most promising Lithium-Ion Battery (LIB) anode materials because its theoretical mass specific capacity, 4,200 Ah/kg, is much higher than any material in use today (see: J. Lee, W. Kim, J. Kim, S. Lim, and S. Lee. Journal of Power Sources 176 [2008] 353-358; L. F. Cui, R. Ruffo, C. K. Chan, and Y. Cui, NanoLetters, 9, 491-495 [2009]; L. F. Cui, Y. Yang, C. M. Hsu, and Y. Cui, NanoLetters, 9, 3370-3374 [2009]); W. Xu and J. C. Flake, J. Electrochem. Soc. 157(1) A41-A45 [2010]). Current battery industry dominant graphite anodes have a theoretical mass specific capacity of 372 Ah/kg (see: D. Linden and T. Reddy. Handbook of Batteries [3^{rd} Edition]). Although Si has such high specific capacity, current battery designs suffer from strain related structural failures that have so far prevented the practical and broad implementation of this highly promising material. The reason is that Si expands as much as 400% upon saturation with Li. This saturation occurs when the battery is charged. The Silicon acts as a charge storage material when the Li ions are inserted into the Silicon. The amount of expansion is determined by the amount of ions or stored charge in the material. On discharge, the expanded Si contracts when the Li ions are extracted. Therefore, the charge/discharge cycle can introduce mechanical failure of the material.

In the Figures:

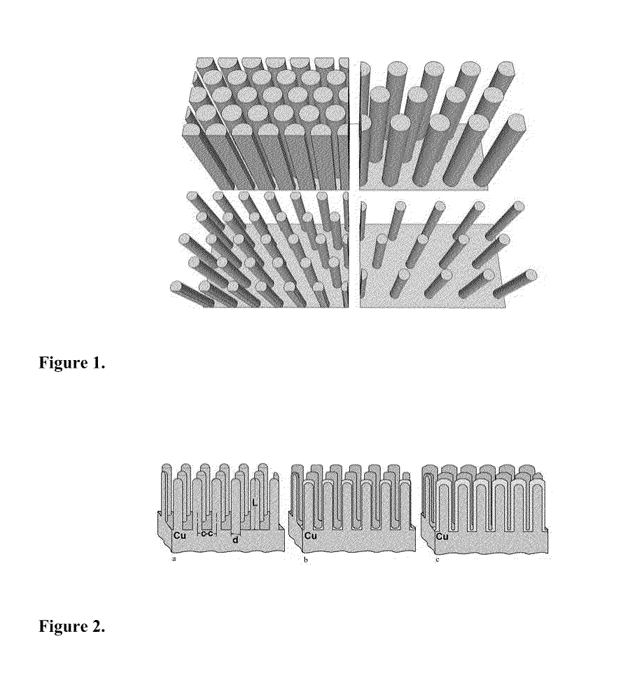

FIG. 1: Schematic of CuNW array of varying attributes with higher density (left) vs. lower density (right) and larger diameter NW's (top) vs. smaller diameter NW's (bottom). (Not drawn to scale)

FIG. 2: Embodiment 1. Conceptual drawing of the innovation, a) CuNW array as the anode substrate, b) CuNW array with a thin film deposit of conformal silicon, with sufficient open interstitial space in between NW's to accommodate up to 400% volumetric expansion of the Si, c) CuNW array with a thicker film of conformal Si, with less open interstitial space where the Si will experience radial compression as it expands to 400%, and d) SiNW array on Cu with a c-Si core and α-Si shell. (Not drawn to scale) Potential NW array specifications are: Dia approximately 2-900 nm, C-C distance approximately 130-980 nm, NW length approximately 0.1-100 microns.

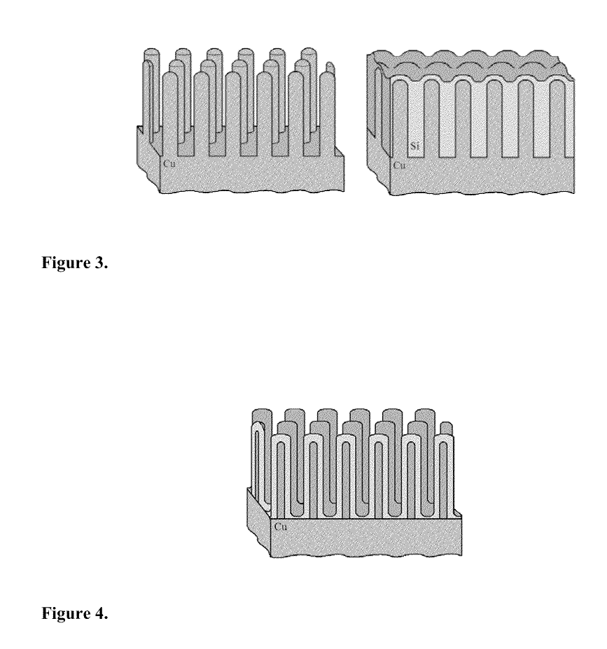

FIG. 3: Embodiment 2. Schematic of CuNW array as the anode substrate, and the CuNW array with a deposit of silicon completely filling the interstitial space within the array. (Not drawn to scale)

FIG. 4: Embodiment 3. SiNW array grown directly on a copper foil. The NW's are single crystal, polycrystalline, amorphous, or amorphous shell over a crystalline core.

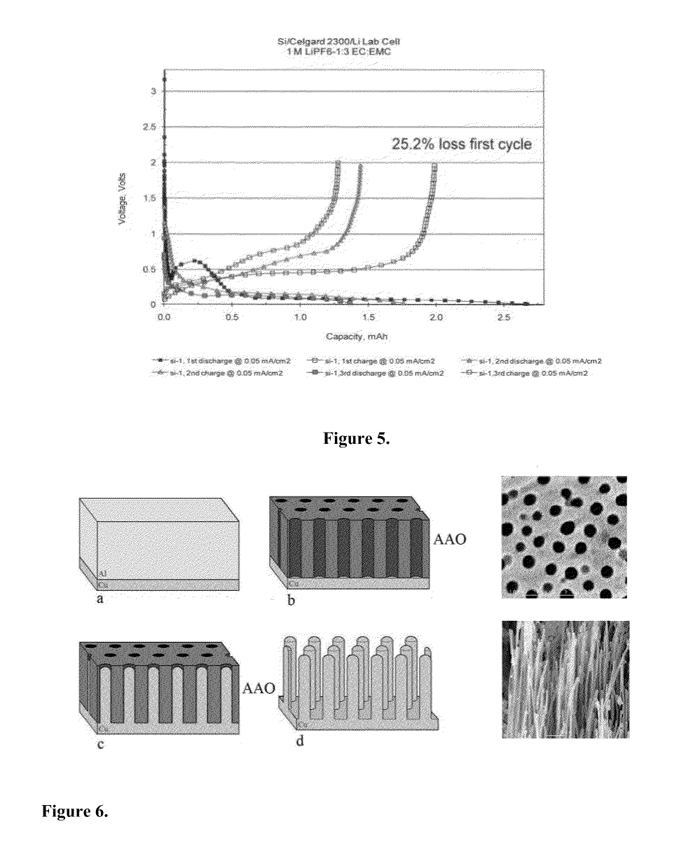

FIG. 5: Cyclic Voltage vs. Capacity (V/mAh)) for Illuminex SiNW based LIB anode.

FIG. 6: Process schematic showing the growth of copper nanowires on copper substrates, (Not drawn to scale). Starting with an (a) Al clad Cu sheet, (b) the Al is anodized forming a hexagonal array of pores, AAO, which is then pore widened to make openings completely through to the copper so that (c) nanowires can be plated to the Cu surface filling the pores. (d) The AAO is etched leaving a free-standing CuNW array. (SEM images of the corresponding AAO and NW Array.)

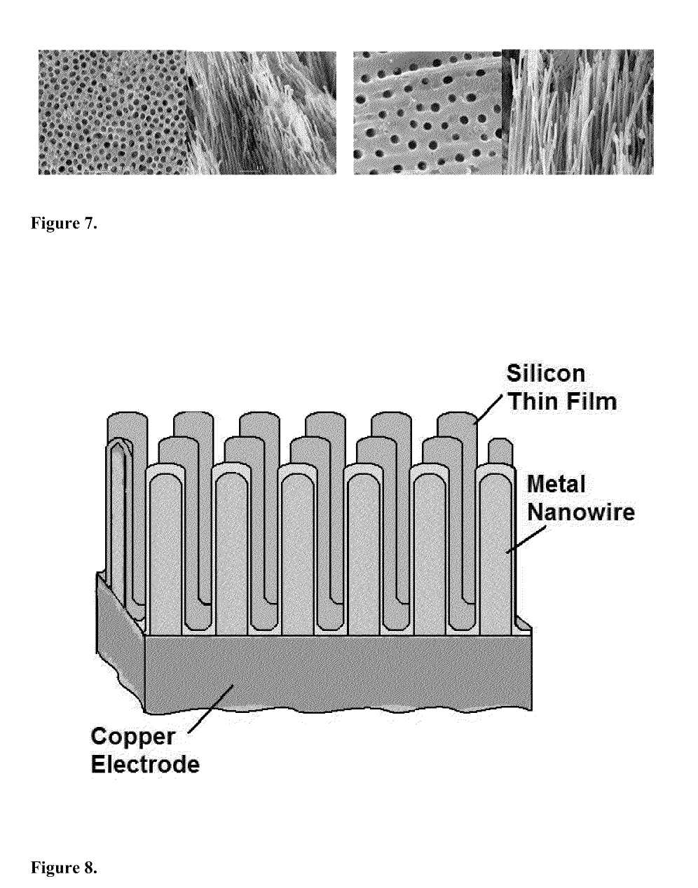

FIG. 7: Porous AAO produced in oxalic acid with its respective CuNW array (left) and tartaric acid with its respective CuNW array (right). Oxalic acid produces a higher density of smaller pores, while malonic acid gives larger pores on a larger pitch. The CuNW array produced from the oxalic acid template is higher density than the array produced from the malonic acid template.

FIG. 8: The Nanowire based Lithium Ion Battery Anode showing the three main components, the electrode, which is typically copper, Metal Nanowires attached to the electrode substrate in an ordered array with controlled diameters and spacing, and a Silicon thin film of a given thickness deposited conformally over the Nanowire array. The Si film is on ohmic contact with the Nanowires which in turn are in ohmic contact with the Electrode. The anode is in an uncharged state, where there is large interstitial spacing between the Si coated nanowires.

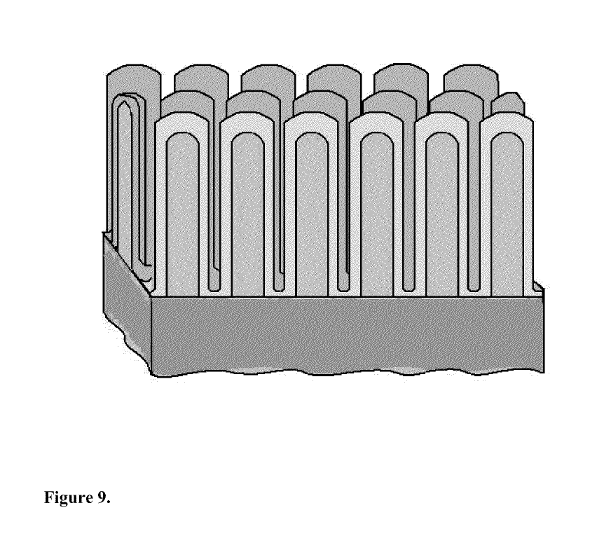

FIG. 9: The same structure as in FIG. 9, but in the charged state. During charging, Lithium alloys with Si to form a range of compounds as high in stoichiometry as Li_{4.4}Si, causing the Si to expand. The nanowire array maintains the alignment and interstitial spacing even after the Si expands upon Lithiation.

### 2. PRIOR ART

To circumvent the high strain problem, several approaches to Si anode fabrication have been studied, the most significant of which have been thin films. The following references are incorporated by reference: Si nanowires and silicon-carbon nanocomposites: J. Lee, W. Kim, J. Kim, S. Lim, and S. Lee. Journal of Power Sources 176 [2008] 353-358; I. Younezu, H. Tarui, S. Yoshimura, S. Fujitani, and T. Nohm, SANYO Electric Co., Ltd., Abs. 58, IMLB12 Metting, © 2004 The Electrochemical Society, Inc.; D. Yu, Y. Xing, Q. Hang, H. Yan, J. Xu, Z. Xi, and S. Feng, Physica E 9 [2001] 305-309; H. Yang, P. Fu, H. Zhang, Y. Song, Z. Zhou, M. Wu, L. Huang, and G. Xu, Journal of Power Sources 174 [2007] 533-537; L. F. Cui, R. Ruffo, C. K. Chan, and Y. Cui, NanoLetters, 9, 491-495 [2009], L. F. Cui, Y. Yang, C. M. Hsu, and Y. Cui, NanoLetters, 9, 3370-3374 [2009]); W. Xu and J. C. Flake, J. Electrochem. Soc. 157(1) A41-A45 [2010]). Xu et al provides a comprehensive review of several studies performed on Si thin films as the active material for Li-ion Cells (the following reference is incorporated by reference: H. Yang, P. Fu, H. Zhang, Y. Song, Z. Zhou, M. Wu, L. Huang, and G. Xu, Journal of Power Sources 174 [2007] 533-537). The highest capacities, >3000 Ah/kg, were observed with films <250 nm thick, and showed no signs of degradation up to 70 charge-discharge cycles. Yang et al produced an anode comprised of a 2000 nm thick amorphous Si (α-Si) film deposited on a Copper (Cu) foil and reported structural and electrical stability for greater than 300 charge-discharge cycles at 1180 Ah/kg when tested in a full-cell format against a LiCoO₂ cathode (see: H. Yang, P. Fu, H. Zhang, Y. Song, Z. Zhou, M. Wu, L. Huang, and G. Xu, Journal of Power Sources 174 [2007] 533-537). Although such high specific capacities were observed, thin films combined with the necessary electrical conductor, i.e. Cu foil, cannot meet the half-cell Volumetric Energy Density goals of 600 Wh/liter and/or Specific Energy Density of 400 Wh/kg. Energy Density is defined in Section 5.

Si structures with nanometer scale dimensions do not experience the high strain that bulk Si structures do, due to homogeneous expansion and ductility and have exhibited improvements in the performance of Si-based anodes (see: Investigating Nanopillars: Silicon Brittle? Not This Kind!, http://www.sciencedaily/2009/10/09100833455.htm). Also nanostructured Si anodes provide other advantages relative to transport kinetics of Li for the insertion/extraction process, and room for the Si to expand as it is alloys with Li. Cui et al demonstrated anodes comprised of SiNW arrays grown by a Vapor-Liquid-Solid (VLS) process on a stainless steel substrate were able to accommodate large strain without mechanical degradation (see: L. F. Cui, R. Ruffo, C. K. Chan, and Y. Cui, NanoLetters, 9, 491-495 [2009] which is incorporated herein by reference). The SiNW arrays also exhibited high charge storage capacity (>1000 Ah/kg, 3 times of carbon) maintaining 90% capacity retention as it approached 100 cycles, but with signs of degradation. Cui et al further demonstrated anodes comprised of carbon nanofibers coated with conformal α-Si films, and reported similar performance as the SINW (see: L. F. Cui, Y. Yang, C. M. Hsu, and Y. Cui, NanoLetters, 9, 3370-3374 [2009]). Additional approaches of combining Si with nanoparticles such as carbon nanotubes also exhibit promising performance (see: W. Wang, P. N. Kumta, J. Power Sources 172 [1007] 650). However it has also been reported that nanometer-sized Si particles in composites tend to agglomerate after the insertion/extraction of Li ions, compromising the various advantages afforded by the nanostructure (see: H. Li, X. Huang, L. Chen, G. Zhou, Z. Zhang, D. You, Y. J. Mo, N. Pei, Solid-State Ionics 135 [2000] 181; R. Teki, M. K. Data, R. Krishnana, T. C. Parker, T-M Lu, P. N. Kumta, and N. Koratkar, Small, 1-7 [2009]).

### 3. SUMMARY OF THE INVENTION

The Illuminex Corporation innovation is an anode comprised of a metallic nano-structured material coated with an active material that is in contact with the lithium electrolyte. In one embodiment, a Cu foil sheet is covered with vertically aligned copper nanowires (CuNW) in an array, and coated with a Silicon film, 10 nm-300 μm thick deposited over the surface, thus forming the Copper Silicon Nano Composite structure (CSNC). A Cu foil with a CuNW array on the surface has surface area enhanced 50 to 10,000 times compared to a planar Cu foil: Thus, a given thickness of Si on a copper NW array will contain a higher volume than the same given thickness of Si on a planar surface. In such a configuration, the Volumetric Cell Capacity exceeds the 600 Wh/liter goal.

FIG. 1 shows examples of CuNW arrays with high and low NW (nanowire) spacing and diameters. As explained in detail in section 4a, Illuminex can produce arrays with the following range of specifications: NW diameter approximately 2-900 nm, Center to center (C-C) distance approximately 50-980 nm, NW length approximately 0.1-100 microns. A square cm of Cu foil with a CuNW array can possess 1 to 10 billion NW's each with a surface area of 50 to 300 billionths of a square cm resulting in a total surface area of 50 to 3000 square cm. One square centimeter of Cu foil can possess as much as 3000 square cm's of NW surface area. The total surface area of the NW array is essentially the surface area of each NW times the number of NW's. The Surface Area Enhancement is defined as the Total Surface Area of the CuNW array divided by the Planar Area of the Cu substrate. A CuNW array is disclosed in U.S. patent application Ser. No. 11/206,632 filed on Aug. 15, 2005, and PCT/US07/63337 both of which are incorporated by reference. In addition is the relevant device disclosed in U.S. patent application Ser. No. 12/281,511 filed on Sep. 3, 2008 all of which are incorporated by reference.

A conformal film of Si, or any other element or compound, such as Germanium (Ge), Tin (Sn), known to alloy with Li or any other species, is deposited on the CuNW array substrate as illustrated in FIG. 2 and FIG. 3. The deposition of Si can be accomplished by various methods including but not limited to Low Pressure Chemical Vapor Deposition (LPCVD), Plasma Enhanced CVD (PECVD), sputtering, some of which are described in references J. Lee, W. Kim, J. Kim, S. Lim, and S. Lee. Journal of Power Sources 176 (2008) 353-358.; L. F. Cui, R. Ruffo, C. K. Chan, and Y. Cui, NanoLetters, 9, 491-495 (2009).; L. F. Cui, Y. Yang, C. M. Hsu, and Y. Cui, NanoLetters, 9, 3370-3374 (2009).; W. Xu and J. C. Flake, J. Electrochem. Soc. 157(1) A41-A45 (2010).; D. Yu, Y. Xing, Q. Hang, H. Yan, J. Xu, Z. Xi, and S. Feng, Physica E 9 (2001) 305-309.; H. Yang, P. Fu, H. Zhang, Y. Song, Z. Zhou, M. Wu, L. Huang, and G. Xu, Journal of Power Sources 174 (2007) 533-537.; W. Wang, P. N. Kumta, J. Power Sources 172 (2007) 650.; and H. Li, X. Huang, L. Chen, G. Zhou, Z. Zhang, D. Yu, Y. J. Mo, N. Pei, Solid-State Ionics 135 (2000) 181 and references contained therein, all of which are incorporated herein by reference. The device is a nanostructured substrate coated with a thin film of active material. The nanostructured substrate is a stable platform that is not chemically or physically altered by the deposited film throughout the fabrication or operation of the device.

A thin film of Si on a CuNW array with high surface area enhancement produces a CSNC LIB anode with high energy density.

Prior art structures of coating carbon nanotubes with silicon present several problems. First, the carbon nanotubes do not have quality and uniform electrical contacts with the substrate. Second, the insertion/extraction cycling that the structure is subjected to presents structural problems. The invention here has an ordered array of metallic nanowires that are connected at one end to the surface of a substrate. In this embodiment the nanowires have a better quality electrical connection to the substrate.

In addition, the nanowires are well ordered and can be constructed with a predetermined thickness and center to center spacing. When a predetermined thickness of silicon is deposited, the coated nanowires can maintain space between them so that the battery electrolyte has a large contact surface area. Furthermore, the spacing can be set by the predetermined parameters so that when charge insertion occurs, the space between the coated nanowires is not filled. This relieves strain on the structure as well as maintaining the high surface area for charge transfer. In another embodiment, the nanowires are entirely coated with silicon. In this embodiment, the metallic nanowires provide a structure that inhibits cracking or deterioration of the silicon due to the charge insertion and extraction cycling. FIG. 8 shows a metallic nanowire array coated with silicon before Li is inserted into it. FIG. 9 shows the same array after the Li has been inserted, for example, as a result of charging the battery. The Silicon layer is now thicker because it has formed an alloy with the Li ions.

Practitioners of ordinary skill will recognize that many metallic nanowires fabricated on a conducting substrate may exhibit the improved characteristics of the invention. For example, they could be Nickel nanowires on a Nickel substrate, or Nickel nanowires on a Copper substrate. Nanowires can also be made of Gold or Silver. In another embodiment, Titanium nanowires can be fabricated with either substrate. In yet another embodiment, Copper nanowires are fabricated on a Copper substrate. In yet another embodiment, the substrate can be indium, tin, silver, gold, palladium, iron, chromium, titanium, nickel, zinc, cobalt or lead. In yet another embodiment, the nanowires can be made of indium, tin, palladium, iron, chromium, zinc, cobalt or lead. In yet another embodiment, the nanowires can be coated with Germanium (Ge) or Tin (Sn).

### a. Embodiment 1

The anode is a copper foil or sheet with a high aspect ratio, high surface area CuNW array on one or both sides, and coated with a conformal film of high capacity Si. The Cu foil with the CuNW array is the substrate providing stable structural support to a conformal film of high capacity Si, and the anode, providing the negative electrical pole for the battery. This anode/electrode design is illustrated in FIG. 2.

The CuNW arrays are produced with NW dia approximately 2-900 nm, center to center (C-C) distance approximately 50-980 nm, NW length approximately 0.1-200 microns as described in Section 2a. The CuNW array substrate is then coated with a conformal film of Si, 1 nm to a maximum thickness less than the one-half the spacing between CuNW's, 2 nm to 300 nm depending on the array specifications, leaving open interstitial volume that is exposed to the battery's electrolyte and can accommodate the expansion of Si as it alloys with Li. To optimize area specific capacity, the NW array properties are balanced between the high surface area enhancement and the interstitial space which allows for thicker Si films and its expansion. The CuNW's provide electrical, thermal, and structural functions to the LIB anode.

The CuNW array bound to a Cu foil acts as a structural support for the chemically active silicon film. The Cu—Si nanostructure results in an anode with a sufficient quantity of Si, in a stable form, to achieve LIB industrial capacity needs. The Cu foil with the CuNW array also provides superior electrical and thermal characteristics. The CuNW array is not altered chemically or physically during the charge-discharge mechanism.

### b. Embodiment 2

The anode is a copper foil or sheet with a high aspect ratio, high surface area CuNW array on one or both sides which is coated with a conformal film of amorphous or crystalline Si using chemical vapor deposition (CVD) sputter coating or other methods. The Cu foil with the CuNW array is the substrate providing stable structural support to a conformal film of high capacity Si. This anode/electrode design is illustrated in FIG. 3. The CuNW arrays are produced with NW dia approximately 2-900 nm, C-C distance approximately 50-980 nm, NW length approximately 0.1-200 microns as described in Section 4a. The CuNW array substrate is then coated with a conformal film of Si, such that the open area of the array is completely filled with Si as illustrated in FIG. 3. The structure is a film of Si, equal in thickness to the length of the CuNW's, on a Cu foil with CuNW's infiltrating the film. The CuNW's provide electrical, thermal, and structural functions to the LIB anode.

The CuNW array bound to a Cu foil acts as a structural support for the chemically active silicon film. The Cu—Si nanostructure results in an anode with a sufficient quantity of Si, in a stable form, to achieve LIB industrial capacity needs. The Cu foil with the CuNW array also provides superior electrical and thermal characteristics. The CuNW array is not altered chemically or physically during the charge-discharge mechanism.

### c. Embodiment 3

The Cu current collector is a planar Cu foil with an AAO (anodized aluminum oxide) template as a substrate for SiNW growth. This electrode design is illustrated in FIG. 4. Due to the existence of several copper-silicide phases SiNW's can be grown via Vapor-Liquid-Solid (VLS) or Vapor-Solid-Solid (VSS) mechanisms (see: V. Schmidt, J. V. Wittemann, S. Senz, and U. Gösele, Advanced Materials, 21, 2681-2702 [2009] incorporated herein by reference). The AAO template controls the geometric characterstics of the SiNW array, for example the center to center spacing and the diameter or thickness of the nanowires. The growth of SiNW arrays is described in greater detail in Section 4b. See also U.S. patent application Ser. No. 11/917,505 filed on Dec. 14, 2007, incorporated herein by reference.

In another embodiment SiNW arrays can be produced using an Au catalyst on an AAO on ITO coated ¾×1″ glass substrate. A Cu electrical contact was evaporated on a portion of the SiNW surface.

### 4. THE ANODE FABRICATION PROCESS

a. CuNW Array Process

Illuminex Corporation has developed a method of producing CuNW arrays directly on copper sheet or foil using electrochemical anodizing and plating processes readily scaled to large scale commercial plating techniques for high volume, low cost manufacturing.

As illustrated in FIG. 6, the CuNW array production starts with copper sheet clad with aluminum (Al) as the precursor material. The entire Al layer is anodized forming a layer of porous anodic aluminum oxide (AAO) directly on the surface of copper sheet. The metrics of the AAO, pore-size, pore-spacing, and thickness, can be controlled by selecting the appropriate process parameters, to create the desired template for the NW array. An example of different AAO templates is given in FIG. 7.

TABLE 1
AAO parameters vs. Electrolyte.

| | C-C Pore | Pore | | |
|---|---|---|---|---|
| | Spacing | Diameter | Pore Length | Area |
| Electrolyte | (nanometers) | (nanometers) | (microns) | Enhancement |
| Oxalic Acid | 100-150 | 40-75 | 50-75 | 300-2000 |
| Tartaric Acid | 250-350 | 75-150 | 50-100 | 150-250 |

The Cu/AAO substrate is then placed in a copper electro-plating bath and copper is deposited into the pores of the AAO forming CuNW's bonded to the copper substrate. The AAO layer is then entirely chemically removed, leaving a copper sheet with a CuNW array as presented in SEM images contained in FIG. 6 and FIG. 7.

The formation of self-ordered nano-porous (AAO) is a practical and flexible starting material for nano-structure fabrication, largely due to the relative ease of production and the large expanse of dimensions that can be obtained. Pores of AAO, 2-900 nm in diameter, can be controllably produced on center-to-center (C-C) distances of 130-980 nm with NW lengths of 0.1-100 microns: with diameters and C-C distances determined by the type, concentration, temperature and voltage applied to the anodization electrolyte (see: S. Z. Chu, K. Wada, S. Inoue, M. Isogai, Y. Katsuta, and A. Yasumori, J. Electrochem. Soc. 153, B384-B391 [2006]; S. Ono, M. Saito, and H. Asoh, Electrochimca Acta, 51, 827-833 [2005]), with the depths controlled by the initial Al thickness. Depending on the above AAO parameters, CuNW arrays can be produced with nanowire pitch, diameter and length, such that the total surface area of the array can be as much as 10,000 times the area of the planar copper substrate. This range of CuNW arrays is conceptually illustrated in FIG. 1.

b. Silicon Deposition and SiNW Growth.

There are numerous Si deposition methods (see: J. Vossen, W. Kern, “Thin Film Processes”, Academic Press, 1978) available to deposit uniform, conformal Si films of varying thickness and morphology over the CuNW arrays. These include LPCVD, PECVD, dc-rf magnetron sputtering, and other processes that are described in references J. Lee, W. Kim, J. Kim, S. Lim, and S. Lee. Journal of Power Sources 176 (2008) 353-358.; L. F. Cui, R. Ruffo, C. K. Chan, and Y. Cui, NanoLetters, 9, 491-495 (2009).; L. F. Cui, Y. Yang, C. M. Hsu, and Y. Cui, NanoLetters, 9, 3370-3374 (2009).; W. Xu and J. C. Flake, J. Electrochem. Soc. 157(1) A41-A45 (2010).; D. Yu, Y. Xing, Q. Hang, H. Yan, J. Xu, Z. Xi, and S. Feng, Physica E 9 (2001) 305-309.; H. Yang, P. Fu, H. Zhang, Y. Song, Z. Zhou, M. Wu, L. Huang, and G. Xu, Journal of Power Sources 174 (2007) 533-537.; W. Wang, P. N. Kumta, J. Power Sources 172 (2007) 650.; and H. Li, X. Huang, L. Chen, G. Zhou, Z. Zhang, D. Yu, Y. J. Mo, N. Pei, Solid-State Ionics 135 (2000) 181 and references contained therein, all of which are incorporated herein by reference. In the preferred embodiments 1 and 2, the Si deposits conformally over the NW array as illustrated in FIG. 2 or FIG. 3.

As in the preferred embodiment 3, SiNW arrays can be grown directly on Cu or Cu/AAO by VLS and VSS at temperatures typically above 800° C., where copper-silicide phases are formed (V. Schmidt, J. V. Witteman, S. Senz, and U. Gösele, Advanced Materials, 21, 2681-2702 [2009] is incorporated herein by reference). In the case an AAO template is used, the formation of the SiNW's initiates in the pores of the AAO, and the resulting NW dimensions will be approximately equivalent to those of the AAO template. Without the template, SiNW growth is stochastic. In that case, the center to center spacing and diameter is less well ordered.

The amount of conformal α-Si can be increased as preferred by changing the reaction conditions at the appropriate stage in the process to inhibit SiNW growth, and promote conformal Si growth.

### 5. CHARACTERIZATION OF THE CuNW ARRAY, THE SILICON LOAD, AND ELECTRICAL PERFORMANCE

Methods to characterize the Si coated CuNW arrays, and/or SiNW arrays includes SEM, electron and x-ray diffraction techniques. NW array parameters, diameter, length, C-C spacing, is determined by SEM, and Si structure is determined by diffraction techniques.

The anode performance of the Illuminex CSNC anode is measured by constructing a standard half-cell consisting of coupling the CSNC anodes with lithium metal counter electrodes in a pouch configuration to determine:
1. Mass Specific Capacity—charge per gram, mAh/gm.
2. Specific Energy Density—Charge per total anode mass (electrical conductor+Si, kg)×electrochemical potential approximately 3V for Si anode), Wh/kg.
3. Volumetric Energy Density—Specific Energy Density (Wh/kg)×Anode Density (kg/liter), Wh/liter.
4. Area Specific Capacity—charge per unit area of copper substrate, mAh/cm². This equals “Mass Specific Capacity”×“Silicon Load”. Silicon Load, # of grams Si deposited per unit area of copper substrate, gm/cm², will be determined by SEM imaging and by wet chemical analysis. Volumetric Energy Density=3V×Area Specific Capacity/anode thickness.
5. First cycle loss—the percent change in charge capacity of the electrode after the first charge-discharge cycle.
6. Fade Rate—the percent change in charge capacity of the electrode per charge-discharge cycle.
7. Specific Capacity as a function of C-rate (C-rate is defined as the discharge rate in which a fully charged battery discharges in one hour).

c. Anode Performance

CuNW array metrics, an example:

Performance can be calculated:

NW dia.—80 nm; C-C spacing—200 nm; NW Length—50 microns

NW density—2.9 billion/cm²; NW surface area=π×80 nm×50μ=1.26E-7 cm²

Area Enhancement=Total CuNW array area/cm² of substrate=NW Surface Area×NW density=1.26E-7 cm²×2.9E9/cm²=365.

However, when the CuNW's are coated with a Si film the effective surface area of the CuNW is greater that calculated above. The effective surface area is the total volume of Si divided by the Si film thickness. The volume the Si annulus about each CuNW is greater than the Surface area of the CuNW×film thickness (50 nm).

Volume of the Si Annulus=π(Radius_{SiFilm+CuNW}_{²}−Radius_{CuNW}_{²})*Length_{CuNW}

Effective Surface Area=Volume_{SiAnnulus}/Thickness_{Film}=π(0.09μ²−0.04μ²)*50μ/)0.05μ=20.4μ²=20.4E-8 cm²

Effective Area Enhancement=20.4E-8 cm²*2.9E9/cm²=592

Cu foil thickness, without the array, is 0.01 mm, 10 microns, standard thickness for the industry. Total thickness is 60 microns, or 0.006 cm

Si Film Dimensions:

For Embodiment 1, the optimum thickness of the Si film is the maximum thickness such that there remains adequate interstitial volume to accommodate the 400% film expansion as Si alloys with Li. For the above CuNW array, maximum thickness is 50 nm. The total Si volume contained a square cm of CuNW array density is the number of NW's×(volume of each coated CuNW (Cu+Si) minus volume of each bare CuNW) or Area Enhancement×Si film thickness.

Calculated maximum performance of silicon anode:

Si Volume/(cm² of electrode)=2.9E9/cm²×5000 nm×π((40+50 nm)²−(40 nm)²)=0.0029 cc_{Si}/(cm²−electrode)

Or 592 cm²/cm²×0.000005 cm=0.0029 cc/(cm²−electrode)

Si mass=0.0029 cc×2.3 g/cc=0.0068 g.

Capacity/cm² of Si based anode=4200 mAh/g×0.0067 g=28.6 mAh/cm².

Volumetric Charge Capacity=28.6 mAh/0.006 cm³=4766 mAh/cc (Anode is 0.006 cm thick)

Volumetric Capacity of Si based Anode=1.43×10⁴ Wh/liter assuming a 3V potential.

Calculated maximum performance of graphite anode:

180 microns thick graphite film on a planar 10 micron Cu foil@372 mAh/g. Total thickness=190 microns, or 0.019 cm.

Graphite volume=0.019 cc

Graphite mass=0.019 cc×2.16 g/cc=0.039 g

Capacity/cm² of graphite based anode=372 mAh/g×0.039 g=14.5 mAh/cm².

Volumetric Capacity of graphite based anode=2.28×10³ Wh/liter assuming a 3V potential.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the specification or figures is intended only to provide an extremely detailed disclosure of the present invention and is not intended to be limiting. The spirit and scope of the present invention are to be limited only by the terms of the appended claims.

1. A battery electrode comprising:
A plurality of metallic nanowires, each metallic nanowire attached at one end to a conductive substrate and extending substantially normal to the surface of the substrate and coated with a charge storage material.

2. The battery electrode of claim 1 where the diameter, center to center spacing of the metallic nanowires and the thickness of the storage material coating are at predetermined dimensions so that the vertical surface of the coated metallic nanowires do not touch when the charge storage material has absorbed a predetermined maximum amount of charge insertion.

3. The battery electrode of claim 1 where the substrate is copper.

4. The battery electrode of claim 1 where the nanowires are Nickel.

5. The battery electrode of claim 1 where the substrate is any of indium, tin, silver, gold, palladium, iron, chromium, titanium, nickel, zinc, cobalt or lead.

6. The battery electrode of claim 1 where the metallic nanowires are any of indium, tin, silver, gold, palladium, iron, chromium, titanium, nickel, zinc, cobalt or lead.

7. The battery electrode of claim 1 where the metallic nanowires are Nickel and the substrate is Copper.

8. The battery electrode of claim 1 where the metallic nanowires are Titanium and the substrate is Copper.

9. The battery electrode of claim 1 where the metallic nanowires are copper and the substrate is copper.

10. The battery electrode of claim 1 where the charge storage material is Germanium.

11. The battery electrode of claim 1 or claim 9 where the charge storage material is Silicon.

12. The battery electrode of claim 1 where the charge storage material coating is 10 nm to 300 microns thick.

13. The battery electrode of claim 1 where the metallic nanowire diameters are between and including 2 to 900 nanometers, center to center spacing approximately 50 to 980 nanometers and length approximately 0.1 to 200 microns.

14. A method of forming a battery electrode comprising:
Forming a plurality of metallic nanowires where each metallic nanowire is attached at one end to a conductive substrate and extend substantially normal to the surface of the substrate; and
Coating the nanowire array with a charge storage material.

15. The method of claim 14 where the forming step is comprised of anodizing a metal using oxalic acid.

16. The method of claim 14 where the forming step is comprised of anodizing a metal using tartaric acid.

17. The method of claim 14 where the forming step is comprised of anodizing a metal using malonic acid.

18. The method of claim 14 where the metallic nanowires are copper and the charge storage material is Silicon.

19. The method of claim 1 where the forming step is further comprised of setting the diameter and center to center spacing of the metallic nanowires to predetermined dimensions and the coating step is comprised of setting the thickness of the storage material coating at a predetermined dimensions so that the vertical surface of the coated metallic nanowires do not touch when the charge storage material has absorbed a predetermined maximum amount of charge insertion.

20. A battery electrode comprising:
A metallic nanowire array where each nanowire is attached at one end to a substrate and extends substantially normal to the surface of the substrate into a film comprised of a charge storage material.

21. The battery electrode of claim 20 where the charge storage material is Silicon.

22. The battery electrode of claim 21 where the metallic nanowires are one of copper or nickel.

23. The battery electrode of claim 22 where the substrate is copper.

24. The battery electrode of claim 20 where the substrate is any of indium, tin, silver, gold, palladium, iron, chromium, titanium, nickel, zinc, cobalt or lead.

25. The battery electrode of claim 20 where the metallic nanowires are any of indium, tin, silver, gold, palladium, iron, chromium, titanium, nickel, zinc, cobalt or lead.

26. A battery comprising:
An anode comprised of a plurality of nanowires, each attached at one end to metallic substrate and extending substantially normal to the surface of the substrate and coated with a charge storage material; and
An electrolyte in operative contact with the outer surface of the charge storage material coating.

27. A method of storing electric charge comprising:
Inserting ions into a layer of charge storage material, said layer coating a plurality of metallic nanowires, said nanowires being attached at one end to a conductive substrate and extending substantially normal to the surface of the substrate.

28. The battery electrode of claim 1 or claim 20 where the charge storage material is in ohmic contact with the metallic nanowires.
